(19) United States
(12) Patent Application Publication
(10) Pub. No.: US 2014/0015301 A1
(43) Pub. Date: Jan. 16, 2014

(54) WEBBING ACCESSORY

(71) Applicants: Eric Perlman, Weymouth, MA (US); Trung Phung, Milton, MA (US)

(72) Inventors: Eric Perlman, Weymouth, MA (US); Trung Phung, Milton, MA (US)

(21) Appl. No.: 13/548,516

(22) Filed: Jul. 13, 2012

(51) Int. Cl. A47D 15/00; B23P 11/00; A62B 35/00; G09B 25/00; B60R 22/10; A44B 11/00

(52) U.S. Cl. 297/468; 24/198; 182/3; 434/365; 29/428

(57) ABSTRACT

An accessory for use with webbing in restraint systems. A free portion of webbing may be secured to a second portion of webbing with the accessory. The accessory may also facilitate controlled adjustment of webbing by an operator.

### FIELD OF THE TECHNOLOGY

One or more aspects relate generally to restraint systems that employ webbing and, more particularly, to accessories for use in such systems.

### BACKGROUND

Restraint systems, such as those involving harnessing, are used in a range of applications including sporting goods, automotive safety and military equipment. For example, a variety of child restraint devices have been developed for use in automobiles and child conveyance devices, such as strollers and infant carriers. These restraint devices, often referred to as infant or child seats, adequately restrain a small child or infant by way of a harness connected to and in cooperation with a seat portion of the device. Webbing is a versatile component of many restraint systems. Webbing is typically made of a light and strong fabric that is woven as a flat strip to engage with system hardware, such as fasteners, ladder locks, buckles and other fittings to facilitate restraint.

### SUMMARY

One or more aspects relate to accessories for use in restraint systems that involve webbing.

In accordance with an aspect of the present invention, an accessory for webbing is provided comprising a structure configured to receive a first portion of webbing and to secure a second portion of webbing, capable of being used to adjust the webbing.

In accordance with some embodiments, the accessory comprises a grip.

In accordance with some embodiments, the grip comprises a pull tab.

In accordance with some embodiments, the structure removably receives the first portion of webbing.

In accordance with some embodiments, the structure includes a bracket for receiving the first portion of webbing.

In accordance with some embodiments, the structure includes a pair of arms for receiving the first portion of webbing.

In accordance with some embodiments, the accessory further comprises a catch configured to impede movement of the accessory.

In accordance with an aspect of the present invention, a harness system is provided comprising at least one connector, webbing engaged with the at least one connector, and an accessory configured to secure a first portion of the webbing and to receive a second portion of the webbing.

In accordance with some embodiments, the at least one connector comprises a ladder lock.

In accordance with some embodiments, the accessory comprises a grip to facilitate adjustment of the harness system.

In accordance with some embodiments, the accessory comprises a bracket configured to removably receive the first or second portions of the webbing.

In accordance with some embodiments, the accessory is constructed and arranged to hamper adjustment of the webbing.

In accordance with some embodiments, the accessory comprises a catch configured to impede movement of the accessory.

In accordance with some embodiments, the at least one connector is associated with a child seat or stroller.

In accordance with an aspect of the present invention, a method of facilitating use of webbing in a restraint system is provided comprising providing an accessory defining an aperture and comprises a bracket, providing instructions to thread a first portion of webbing through the aperture, and providing instructions to engage a second portion of webbing with the bracket of the accessory.

In accordance with some embodiments, the method comprises providing instructions to adjust the webbing with the accessory.

In accordance with some embodiments, the method comprises providing the restraint system including the webbing.

In accordance with an aspect of the present invention, a restraint system is provided that comprises a child seat and a harness subsystem incorporated into the seat, comprising at least one connector, webbing engaged with the at least one connector, and an accessory configured to secure a first portion of the webbing and to receive a second portion of the webbing.

In accordance with some embodiments, the child seat is a car seat.

In accordance with some embodiments, the child seat is a stroller seat.

In accordance with an aspect of the present invention, a method of making a webbing accessory is provided comprising fabricating a structure configured to receive a first portion of webbing and to secure a second portion of webbing.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1A is a perspective view of an accessory for a restraint system in accordance with one or more embodiments;

FIG. 1B is a side view of an accessory for a restraint system in accordance with one or more embodiments;

FIG. 1C is a perspective view of an accessory for a restraint system in accordance with one or more embodiments;

FIG. 2A is a perspective view of an accessory for a restraint system comprising a locking mechanism in accordance with one or more embodiments;

FIG. 2B is a side view of an accessory for a restraint system comprising a locking mechanism in accordance with one or more embodiments;

FIG. 3A is a perspective view of a portion of a harness system in accordance with one or more embodiments;

FIG. 3B is a bottom view of a portion of a harness system in accordance with one or more embodiments; and

FIG. 4 is a schematic of a harness system in accordance with one or more embodiments.

### DETAILED DESCRIPTION

One or more embodiments relate generally to securing mechanisms, such as restraint systems or harnesses that employ webbing. Certain embodiments relate specifically to securing mechanisms of child restraint devices. Other embodiments may find use in other applications including sporting goods, automotive safety and military equipment. Accessories in accordance with one or more embodiments may increase security and ease of operation of restraint systems. In some embodiments, an accessory may beneficially facilitate adjustment of webbing. In at least some embodiments, an accessory may prevent unintended shifting of the webbing. Movement of the accessory itself may also be hampered. In some embodiments, a free portion of webbing may be secured for safety and convenience.

Conventional child seats generally include a main body that has a child support area disposed on its upper or interior surface to receive a child or infant in a sitting position. The child support area of the main body may include a lower seat portion upon which a child may sit, and an upper back portion for supporting the back of the child.

Child seats are generally equipped with a harness system to restrain a child within the device. The harness system may include multiple sections of webbing that are joined by connecting mechanisms. A harness configuration may comprise a “five point” harness. A five point harness may include webbing sections that form a lap belt portion, a crotch restraint portion, and two shoulder restraint portions. In a five point harness, the belt portion generally extends from, or at the sides of, the main body of the child seat to restrain the child about its waist. A crotch restraint portion is generally positioned between the child's legs and extends from the base of the child seat to the lap belt portion. The shoulder restraint portions generally extend from the upper back portion of the seat body over the child's shoulders and restrain the child about the chest. These portions may be collectively engaged by a buckle mechanism that positions about the child's midsection. Some portions of webbing may be permanently secured in the buckle mechanism. Other portions of webbing may terminate in hardware, such as latch plates, that may be releasably secured in the buckle. When the latch plates are not engaged with the buckle mechanism, the attached portions of webbing are freely movable and the harness is not secured. The harness may be secured by inserting the latch plates into the buckle, thus engaging the lap belt portion, crotch restraint, and shoulder harness portions to form a network of webbing capable of adequately restraining the child.

Once a child has been placed in the seat and the harness system is engaged, it is often necessary to tighten the harness. Likewise, to disengage the harness and remove a child from the seat, it is often necessary to first loosen the system. Tightening and loosening may be accomplished by adjusting the relative lengths of portions of the webbing. Portions of the webbing are commonly threaded through ladder locks that allow an operator to shorten or lengthen the portions that restrain the child. To tighten the webbing, the operator pulls on a free end of the webbing. This causes more of the webbing to be thread through the ladder lock and shortens the length of webbing between the main body of the seat and the buckle, causing the harness to tighten about the child. To loosen the webbing, the operator causes the ladder lock to lengthen the portion of webbing between the body and buckle, often by pulling the ladder lock itself or by manipulating a portion of the free webbing back through the ladder lock and towards the seat body.

The free portion of webbing which allows an operator to manipulate a harness system presents an obstacle to safe child restraint. Because a portion of webbing remains free and unsecured from the harness or main body of the child seat, it can be manipulated by an infant or child secured in the seat. Infants and children restrained by webbing harnesses thus may play with, and undesirably manipulate, the free end of webbing. This manipulation can lead to dangerous over-tightening or loosening of the harness. Webbing ends may collect dirt and bacteria and infants and young children may undesirably engage the webbing end with their mouth. Furthermore, the free end of webbing may fray or otherwise degrade over time due to frictional contact or other manipulation. Degradation of webbing may shorten the usable lifespan of a restraint device. These points are also of concern in other types of restraint systems and harnessing which involve webbing.

In accordance with one or more embodiments, a harness system may include webbing, at least one hardware component, such as a connecting mechanism, and at least one accessory. In accordance with one or more embodiments, an accessory for a child restraint system may advantageously receive a free portion of a webbing harness and secure it to another portion of the webbing harness. The accessory may be made of any material of adequate strength for the intended application and may be of any size and shape based upon the intended application. The accessory may thus be made of plastics, rubbers, metals, or other suitable materials. The accessory may be molded, injection molded, extruded, or otherwise formed in accordance with the selected material.

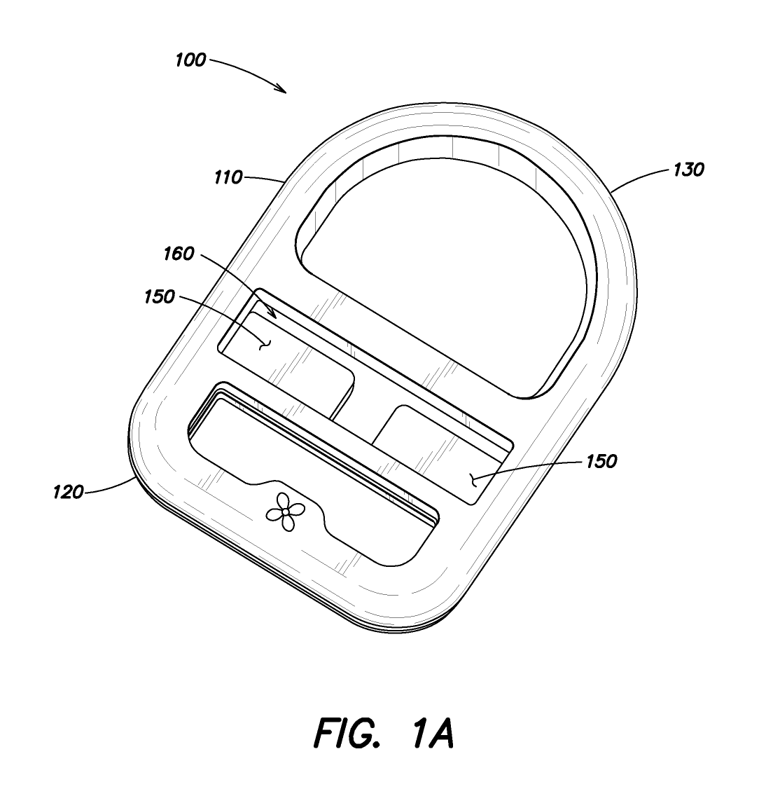

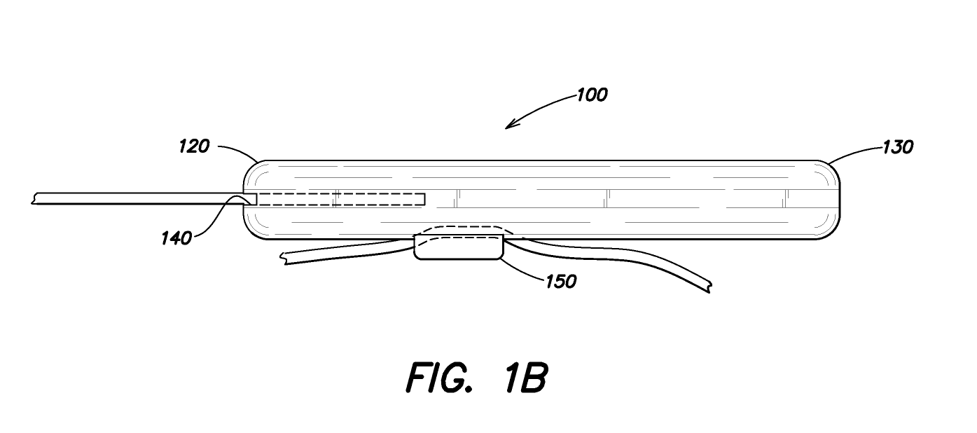

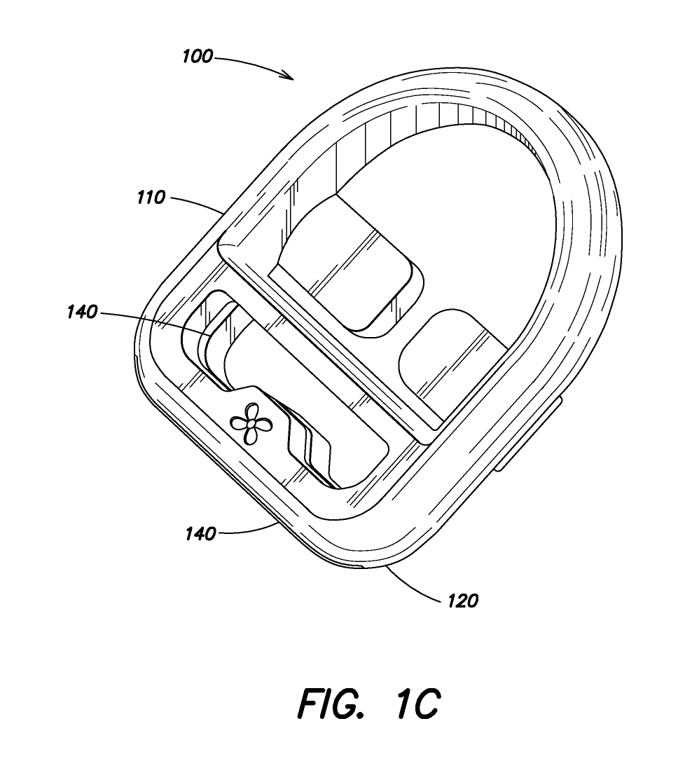

In accordance with one or more embodiments and referring to FIGS. 1A and 1B, an accessory 100 for a restraint system may increase the overall safety of the system. FIG. 1C shows an alternative embodiment of accessory 100. Accessory 100 may include general structure 110. Structure 110 has a first end 120 oppositely disposed from a second end 130. Structure 110 further defines an aperture 140 to receive webbing. In some embodiments, webbing aperture 140 may be proximate to first end 120.

The accessory of one or more embodiments is capable of securing a first end of webbing, such as a free end, to a second portion of the webbing. Referring now to FIG. 1B, accessory 100 may receive a free end of webbing in aperture 140, as shown by the dotted lines that define and extend from aperture 140, to protect the free end of webbing from undesirable degradation and to discourage undesirable manipulation of or contact with the free end.

In accordance with one or more embodiments and referring to FIGS. 1A and 1B, accessory 100 may further comprise a fixing mechanism, such as bracket 150 configured to secure structure 110 to a portion of webbing. In some embodiments, bracket 150 is disposed on the underside of structure 110. Bracket 150 may define a space 160 between the bracket 150 and structure 110. Space 160 is configured to accommodate and engage webbing. Referring now to FIG. 1B, the accessory may be fixed to a second portion of webbing, as shown by the dotted lines that extend through bracket 150. Fixing mechanism 150 may also advantageously secure the accessory structure to a portion of the restraint harness.

In accordance with one or more embodiments, accessory 100 may include an adjustment member. In some embodiments, the adjustment member may be proximate to a second end of the structure. As shown in FIG. 1A, end 130 comprises a grip, such as a pull tab. An operator may grasp end 130 more easily than they could grasp webbing. An operator may beneficially use the adjustment member to facilitate the tightening or loosening of the harness system by, for instance, engaging their fingers around the pull member of end 130. The operator may, via the pull member, exert more force than would be possible by grasping the webbing alone. An operator may engage the pull mechanism and thus more easily tighten a harness system. The adjustment member may therefore facilitate manipulation of the webbing and increase the ease with which an operator can restrain or remove a child from a child restraint device.

In accordance with one or more embodiments and referring to FIG. 1A, accessory 100 may removably secure to webbing. Fixing mechanism 150 may include two arms oppositely disposed from one another that allow the accessory to secure to, and be removed from, a portion of webbing. Webbing may be introduced into space 160 by being thread through the gap defined by fixing mechanism arms 150. Once webbing is received in space 160, fixing mechanism 150 prevents accessory 100 from easily being removed from the received webbing. The webbing may subsequently be removed by re-threading the webbing through the gap created by fixing mechanism arms 150. In accordance with one or more embodiments, the accessory may be permanently secured to webbing. The fixing mechanism may include a single solid arm that extends the entire width of the accessory. The accessory may prevent movement away from the webbing received in the space defined by the fixing mechanism and structure. Once a free end of webbing has been received by the accessory aperture, and the accessory has been secured to a subsequent portion of webbing by the fixing mechanism, the portion of webbing used to adjust the harness may only be moved transversely along the webbing to which the accessory is secured.

In one or more embodiments, an accessory for a restraint system may further include a mechanism, such as a locking mechanism, configured to interfere with movement of the accessory. When engaged, the mechanism may interfere with movement of the accessory along the portion of webbing to which it is secured. The mechanism may provide an additional safeguard against the inadvertent manipulation of webbing by a restrained infant or child. The mechanism may include a friction element or pressure element that, when engaged, exerts a force on the webbing to which the accessory structure is secured. The frictional element may thus provide a frictional force that slows or stops movement in relation to the webbing to which it is secured. When disengaged, the friction element does not exert substantial force on the webbing and thus the accessory can be moved freely.

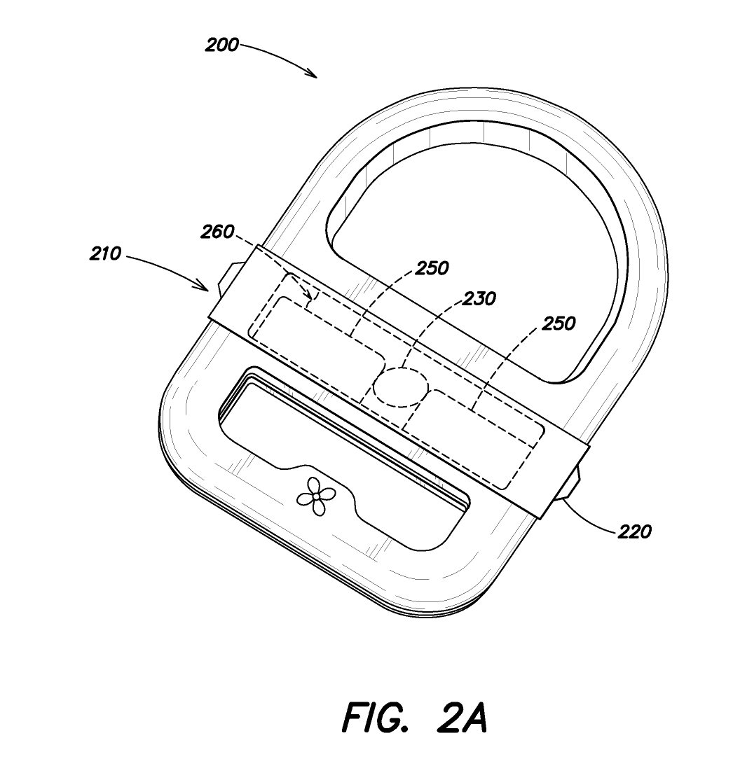

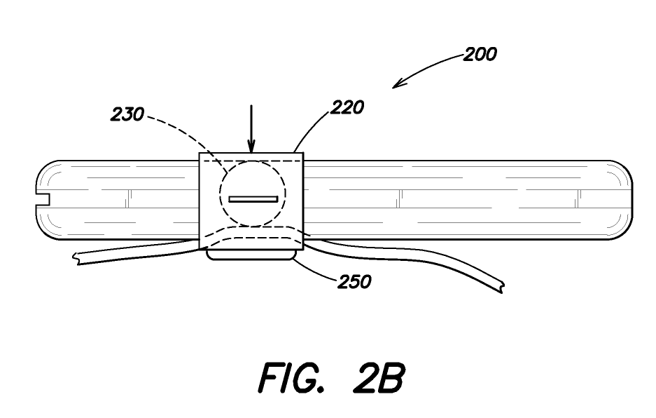

Referring specifically to FIGS. 2A and 2B, accessory 200 may include locking mechanism 210. Mechanism 210 has casing 220 which contains friction ball 230. When engaged, friction ball 230 is forced downward in to webbing in space 260. Friction ball 230 cooperates with fixing mechanism 250 to exert a force on the webbing capable of interfering with movement of accessory 200 in relation to the webbing occupying space 260.

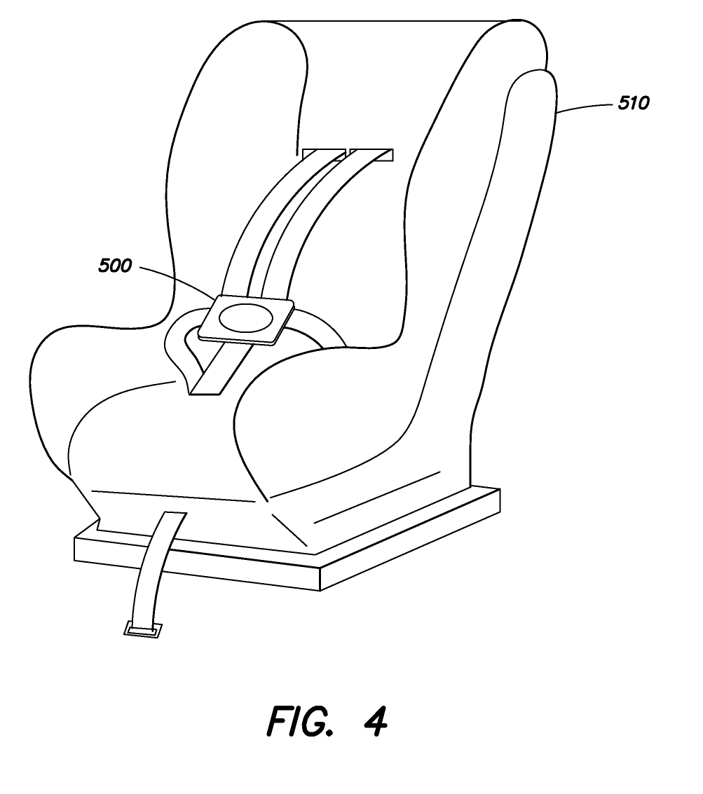

One or more embodiments relate generally to an overall harness system. A harness system may be any system that operates to restrain a subject or object in a desired position. In accordance with FIG. 4, a harness system 500 may be incorporated into a child seat 510, such that the seat operates to restrain an infant or child. Harness system 500 may have a lap belt portion, a crotch restraint portion, and shoulder restraint portions capable of cooperating with seat 510 to restrain a child.

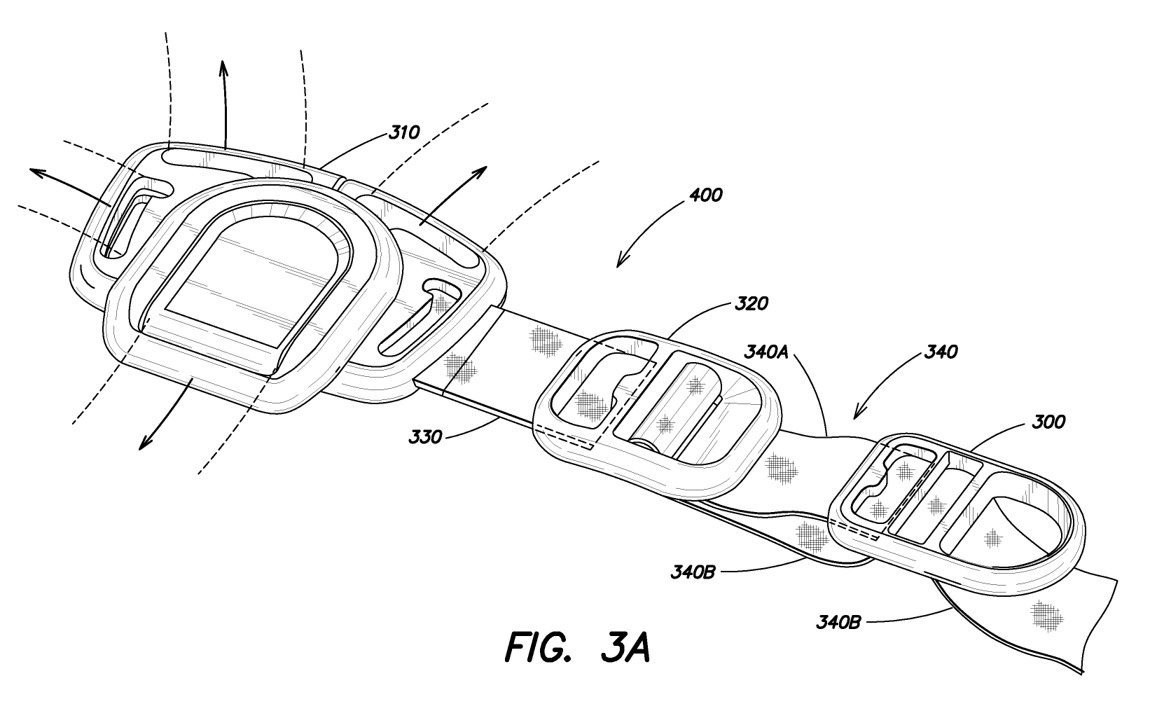

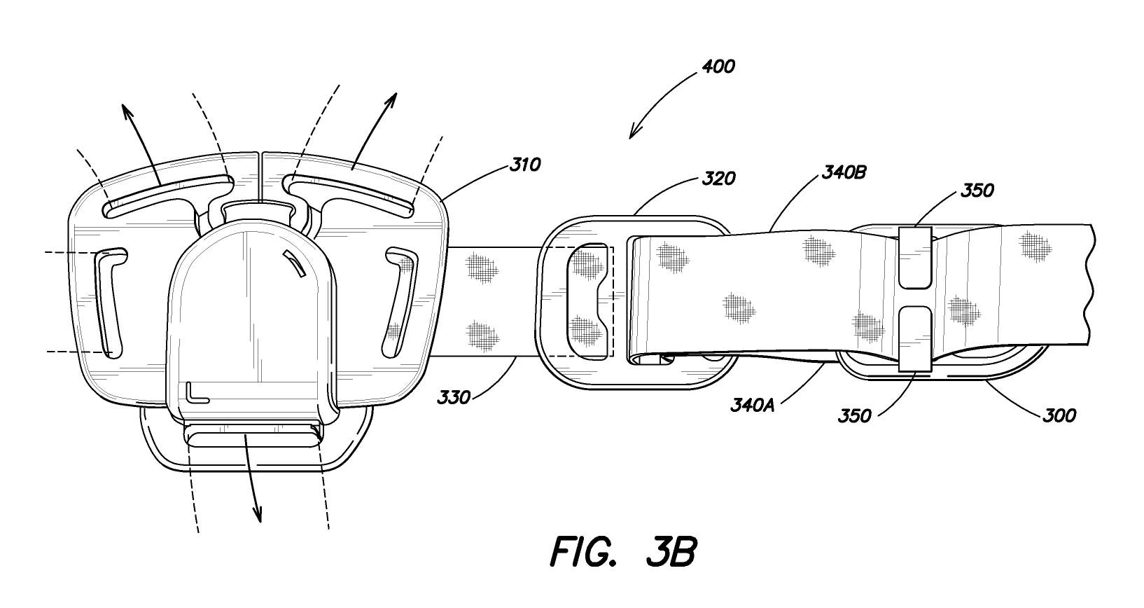

In accordance with one or more embodiments and referring to FIGS. 3A and 3B, a representative portion of a harness system 400 may comprise connecting mechanisms, webbing, and accessories. A connecting mechanism may be any mechanism capable of cooperating with other harness elements to provide a restraint system. Connecting mechanisms may therefore cooperate with harness webbing, to create a webbing network configured to provide restraint. Connecting mechanisms may include buckles, including buckles that comprise latch plates, ladder locks, or any other element that can aid in the configuration of the harness system. Representative harness system 400 has buckle 310 and ladder lock 320. Buckle 310 and ladder lock 320 are connected by webbing 330. Webbing 330 may be in cooperation with a latch plate of buckle 310 (not shown) such that webbing 330 and ladder lock 320 can be separated from, and reattached to, buckle 310.

Ladder lock 320 is further in communication with webbing 340. Webbing 340 has an upper portion, 340A, and a lower portion 340B. Upper webbing portion 340A is defined by the portion of webbing 340 that is thread, from bottom to top, through ladder lock 320. Webbing 340 could alternatively be thread from top to bottom. Bottom webbing portion 340B is webbing portion 340 that is not threaded through ladder lock 320. Bottom portion 340B may extend, as shown by dotted lines, and be fixed to a child seat to form a lap belt portion of a harness system. Webbing 340 is fixed in length. Upper portion 340A and bottom portion 340B may be shortened or lengthened via ladder lock 320. As one portion shortens, the other portion necessarily lengthens. Webbing 340B controls the length of the lap belt portion of harness system 400. As 340B shortens, the overall lap belt shortens in length and tightens about an occupant.

Harness system 400 may be tightened by causing more of bottom webbing portion 340B to be thread through ladder lock 320. This is commonly done when an operator applies force to webbing upper portion 340A in a direction that causes portion 340A to lengthen. The force exerted on webbing 340A causes bottom portion 340B to shorten, as more of webbing bottom portion 340B is thread upward through the ladder lock (thus becoming 340A). As 340B shortens, the length of the lap belt shortens and tightens about an occupant. The harness may be loosened by causing more of webbing 340A to be thread downward into the ladder lock and lengthen portion 340B.

Harness system 400 further includes accessory 300. Referring to FIG. 3A, accessory 300 receives the free end of upper webbing portion 340A in an aperture (not shown). Accessory 300 thus protects the free end of webbing from degradation. Referring to FIG. 3B, accessory 300 comprises fixing mechanism 350. Fixing mechanism 350 is disposed below the structure that defines the webbing aperture to define a space configured to accommodate webbing. As shown in FIGS. 3A and 3B, fixing mechanism 350 secures accessory 300 to bottom webbing portion 340B.

In accordance with one or more embodiments, fixing mechanism 350 allows accessory 300 to traverse along bottom webbing portion 340B. Thus, the fixing mechanism allows adjustment of the webbing harness by an operator even when the accessory is fixed to portion of the harness.

In accordance with one or more embodiments, accessory 300 may comprise a locking mechanism (not shown). A locking mechanism, when engaged, may interfere with movement of the accessory along webbing portion 340B. Thus when the locking mechanism is engaged, the ratio of webbing portion 340A to 340B cannot be as easily changed. The locking feature may further safeguard against any undesirable manipulation of the harness by an occupant.

Harness system 400 may be incorporated into a child seat to restrain a child. FIGS. 3A and 3B show a representative lap belt portion of harness 400. As shown by dotted lines in FIGS. 3A and 3B, webbing extends horizontally from the side of buckle 310, opposite webbing 330, to integrate with and fix to a child seat. This opposite portion of the harness may include connecting mechanisms and accessories. It is to be understood that the connecting mechanisms and accessories described herein may also be used in other portions of a harness system, including shoulder and/or crotch restraints. Additional webbing may, for instance, extend vertically from buckle 310, as shown by dotted lines in FIG. 3A, to form shoulder restraints or a crotch restraint. This webbing may be accompanied by additional connecting mechanisms and accessories. A webbing accessory may, for instance, be incorporated into the shoulder restraint portions of a harness system to facilitate restraint of an occupant.

Existing systems may be retrofitted by providing and implementing an accessory in accordance with one or more embodiments. Instructions may be provided to engage the accessory with webbing in accordance with one or more embodiments.

It is to be appreciated that embodiments of the accessories, systems and methods discussed herein are not limited in application to the details of construction and the arrangement of components as set forth in the above description or illustrated in the accompanying drawings. The accessories, systems and methods are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the apparatus and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. Any references to positional or spatial orientation are intended for convenience of description, not to limit the present apparatus and methods or their components.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. An accessory for webbing, comprising:
a structure configured to receive a first portion of webbing and to secure a second portion of webbing, capable of being used to adjust the webbing.

2. The accessory of claim 1, further comprising a grip.

3. The accessory of claim 2, wherein the grip comprises a pull tab.

4. The accessory of claim 1, wherein the structure removably receives the first portion of webbing.

5. The accessory of claim 1, wherein the structure includes a bracket for receiving the first portion of webbing.

6. The accessory of claim 1, wherein the structure includes a pair of arms for receiving the first portion of webbing.

7. The accessory of claim 1, further comprising a catch configured to impede movement of the accessory.

8. A harness system, comprising:
at least one connector;
webbing engaged with the at least one connector; and
an accessory configured to secure a first portion of the webbing and to receive a second portion of the webbing.

9. The system of claim 8, wherein the at least one connector comprises a ladder lock.

10. The system of claim 8, wherein the accessory comprises a grip to facilitate adjustment of the harness system.

11. The system of claim 8, wherein the accessory comprises a bracket configured to removably receive the first or second portions of the webbing.

12. The system of claim 8, wherein the accessory is constructed and arranged to hamper adjustment of the webbing.

13. The system of claim 12, wherein the accessory comprises a catch configured to impede movement of the accessory.

14. The system of claim 8, wherein the at least one connector is associated with a child seat or stroller.

15. A method of facilitating use of webbing in a restraint system, comprising:
providing an accessory defining an aperture and comprising a bracket;
providing instructions to thread a first portion of webbing through the aperture; and
providing instructions to engage a second portion of webbing with the bracket of the accessory.

16. The method of claim 15, further comprising providing instructions to adjust the webbing with the accessory.

17. The method of claim 15, further comprising providing the restraint system including webbing.

18. A restraint system comprising:
a child seat; and,
a harness subsystem incorporated into the child seat, comprising;
at least one connector;
webbing engaged with the at least one connector; and
an accessory configured to secure a first portion of the webbing and to receive a second portion of the webbing.

19. The restraint system of claim 18, wherein the child seat is a car seat.

20. The restraint system of claim 18, wherein the child seat is a stroller seat.

21. A method of making an accessory for webbing, comprising:
fabricating a structure configured to receive a first portion of webbing and to secure a second portion of webbing.
